(19) United States
(12) Patent Application Publication
(10) Pub. No.: US 2002/0009576 A1
(43) Pub. Date: Jan. 24, 2002

(54) Specialty microporous films and laminated media with applications in ink jet and digital printing

(76) Inventors: Thomas Z. Fu, Milford, OH (US); Yaoliang Hong, Oakland, NJ (US); Hiroshi Tomimasu, Monroe, NY (US)

Correspondence Address: Dennis M. Flaherty, Ostrager Chong & Flaherty LLP, 825 Third Avenue, New York, NY, 10022-7519, US

(21) Appl. No.: 09/867,227

(22) Filed: May 29, 2001

Related U.S. Application Data
(60) Provisional application No. 60/207,924, filed on May 30, 2000.

(51) Int. Cl. B41M 5/00

(52) U.S. Cl. 428/195

(57) ABSTRACT

Ink receiving media for use in ink jet printing and other digital printing applications. The ink jet media each include a microporous film of polymeric material. In one embodiment, a hydrophobic microporous polymeric film is treated with a hydrophilic polymeric melt additive. In another embodiment, a microporous polymeric film is coated with a microparticle coating comprising colloidal or submicron inorganic pigment particles and organic polymers as binders. Optionally, the microporous polymeric film is laminated to any one of a variety of substrates.

### PRIORITY CLAIM

This application claims priority from U.S. Provisional Patent Application No. 60/207,924 filed on May 30, 2000.

### FILED OF THE INVENTION

The present invention generally relates to ink receiving or image recording media for use in ink jet and digital printing. In particular, the invention relates to print media having a microporous layer or coating for ink reception.

### BACKGROUND OF THE INVENTION

Ink jet printing is a technology in which color dots are formed on a substrate by ink droplets ejected from nozzles in a printhead. An exemplary ink jet printer, designed for printing on paper, comprises a printhead and a sheet or web feeding mechanism, both of which are controlled by a printer controller in the form of a microprocessor. The ink jet printer is in turn controlled by a host computer operated by a user via an operator interface (e.g., a keyboard). The host computer 28 is connected to the ink jet printer by an electrical cable and appropriate interfaces.

Ink is applied to an ink-receiving substrate by the printhead, which bombards the substrate surface with droplets of ink from a reservoir, e.g., a conventional ink jet cartridge, via a multiplicity of nozzles or jets. The printhead may be stationary or of the scanning variety. In the case of a stationary printhead, an array of nozzles 10 extends across the full width of the paper and ink is applied as the substrate is continuously translated by a sheet or web feeding mechanism, such as feed rollers. Motors for driving rotation of the feed rollers are under the control of the microprocessor. In the case of a scanning printhead, the substrate is moved in increments by the sheet or web feeding mechanism. After each incremental translation, the substrate is stationary while the printhead is translated across the width of the substrate.

Whether the substrate or the printhead is moved during printing, the nozzles are electrically activated and individually controlled by the microprocessor. The microprocessor in turn receives instructions from the host computer. The host computer comprises a CPU and memory for storing computer code corresponding to the desired digital pattern or image. The microprocessor then controls the printhead in accordance with printing instructions transmitted by the host computer.

Ink jet printers have come into general use for wide-format electronic printing for applications such as, engineering and architectural drawings. Because of the simplicity of operation and economy of ink jet printers, this image process holds promise for the printing industry to produce wide-format, image on demand, presentation quality graphics.

The inks used in ink jet printing are generally composed of water, a water-soluble dye or a pigmented dye, one or more water-miscible co-solvents, and one or more surfactants. The substrate (ink receiving medium) can be plain paper, coated paper, plastic film, cloth, and any other media which can absorb ink and form a good image.

In order to form a high-resolution image, the ink jet printing substrate usually has a specially formulated ink-receiving or image-recording coating. These coatings can be divided into two major categories, fully dense coatings and porous coatings.

The fully dense coatings are mainly comprised of film-forming polymers, with at least one of the polymers being hydrophilic. This hydrophilic polymer is either water soluble or water swellable. Sometimes a small amount of pigment is incorporated into these coatings. This type of coating gives a glossy surface and is usually transparent. The fully dense coatings absorb ink and form an image through rapid swelling of the coating itself. The major disadvantages of this type of coating include the long ink dry time, low water resistivity of both the coating and the printed image, sensitivity of the image quality to the environment, and the difficulty in achieving a “universal” medium which would perform on all printers.

The second type of coating for ink jet applications is porous. A porous coating is usually composed of inorganic or organic pigment particles bonded together by a binder. During the ink jet printing process, ink droplets are rapidly absorbed into the coating through capillary action and the image is dry soon after it exits the printer. Therefore, porous coatings allow a fast “drying” of the ink and produce a smear-resistant image. The dye molecules adsorb on the surface of the particles and form an image. High water resistance of both the coating and the image can be achieved with the porous coating. The performance of the porous ink jet coating is less sensitive to the compositions of the ink and is also much less sensitive to the temperature and humidity of the environment. The disadvantages of this type of coating, however, is the difficulty in achieving high gloss due to the high porosity in the coating.

The pigments used in ink receiving coatings in ink jet printing applications are usually clay, calcium carbonate, magnesium carbonate, silica, surface-modified silica, zeolite, and alumina. A combination of two or more of the above-mentioned pigments can also be used. Most of these porous coatings are opaque. Therefore, dye molecules should be kept on the top surface layer in order to achieve high optical density. Pigments with high surface area are desirable, in order to keep the dye molecules on the surface layer. Silica pigments are especially preferred in ink jet applications due to the availability of a variety of silica gels and precipitated silica with high surface area and high internal pore volume. The porous coatings composed of porous particles such as silica or zeolite possess fast drying characteristics. The binders for these coatings are usually hydrophilic binders such as polyvinyl alcohol. The waterfastness of the coating is a function of the pigment to binder ratio.

A porous coating composed of uniform colloidal particles can provide uniform pore size distribution, which results in high image resolution. The disadvantage of this type of coating is the low mechanical strength of the coating. The porosity only comes from interstitial pores (which are pores created by the particles themselves), i.e., the spaces between the particles, since the colloidal particles themselves are fully dense. As a result, the porosity of this type coating is usually lower than the coating composed of porous particles, which means an even thicker coating is needed to accommodate all the inks. The thicker the coating, the more brittle it becomes.

While a wide variety of different types of image-recording layers for use in ink jet printing applications devices have been proposed, there are many unsolved problems in the art and many deficiencies in the known products which have severely limited their commercial usefulness. The requirements for an image recording medium or element for ink jet recording are very demanding. It is well known that in order to achieve and maintain photographic-quality images on such an image-recording element, an ink jet recording element must: (1) be readily wetted so there is no puddling, i.e., coalescence of adjacent ink dots, which leads to nonuniform density; (2) exhibit no image bleeding; (3) exhibit the ability to absorb high concentrations of ink and dry quickly to avoid elements blocking together when stacked against subsequent prints or other surfaces; (4) provide a high level of gloss and avoid differential gloss; (5) exhibit no discontinuities or defects due to interactions between the support and/or layer(s), such as cracking; and (6) have an optimized image fastness to avoid fade from contact with water or light.

It is desirable to use a porous material in an ink jet recording element due to its liquid-absorbing capability which yields effective drying. This fast dry time can enhance the printing efficacy, and in many cases, can improve the printing quality by eliminating the bleeding of two adjacent colors in the print.

In recent years increasing interest has been shown in microporous films as ink jet printing substrates to address some or all of the above disadvantages. After ink jet printing, the ink absorbs into the pores of the film by capillary action. The substrate feels dry very quickly because the ink is away from the surface of the printed graphic. The film need not necessarily contain water-soluble or water-swellable polymers, so potentially could be heat and UV resistant and need not be subject to water damage.

Microporous films are not necessarily receptive to water-based ink if the material is inherently hydrophobic and methods of making such films hydrophilic have been disclosed in the art. Other films are inherently aqueous ink absorptive because of the film material, e.g. Teslin™, a silica-filled polyolefin microporous film, available from PPG Industries and of the type disclosed in U.S. Pat. No. 4,861,644.

Another method of manufacturing an ink jet printing substrate is to the coat a microporous film with an ink receiving layer as disclosed in U.S. Pat. No. 5,605,750.

There is a need for an improved ink jet printing medium which achieves fast ink drying together with high gloss, good waterfastness, good lightfastness and durable image for narrow- and wide-format applications.

### SUMMARY OF THE INVENTION

The present invention is directed to ink receiving media for use in ink jet printing and other digital printing applications. In particular, the ink jet media of the invention comprise a microporous layer of polymeric material. In accordance with a first preferred embodiment, a hydrophobic microporous polymeric layer is treated with a hydrophilic polymeric melt additive. In accordance with a second preferred embodiment, a microporous polymeric layer is coated with a microparticle coating comprising colloidal or submicron inorganic pigment particles and organic polymers as binders. Optionally, the microporous polymeric layer can be laminated to any one of a variety of substrates.

The invention is further directed to methods for manufacturing the above-described ink receiving media and to methods for manufacturing ink receiving media of the foregoing types having printed matter on an ink receiving surface thereof.

### DETAILED DESCRIPTION OF THE PREFERRED EMBODIMENTS

The present invention is directed to modifying hydrophobic microporous film to a hydrophilic form, which will facilitate water-based ink absorption. One preferred embodiment of the invention is directed to bulk treatment wherein a modified microporous film is made by blending a hydrophobic polymeric material with a hydrophilic polymer melt additive and then forming a film, e.g., by extrusion. This film is then mechanically stretched to form the desired microstructure. In this case, additional coatings are not required to impart hydrophilicity since the addition of the melt additives causes the film to be hydrophilic and thereby receptive to water-based inks. Techniques other than stretching can be used to form controlled micropores in the film.

The addition of the hydrophilic polymer melt additive directly to the polymer host resin is accomplished at a range of concentration sufficient to form a compatible hydrophilic blend. The mechanism of hydrophilization of a hydrophobic polymer surface is based on the migration of some hydrophilic surface active molecules to the surface, which imparts hydrophilicity to the surface.

The polymer blend made accordingly undergoes a series of film making and stretching steps to become a hydrophilized, microporous ink-jet-printable substrate with fast ink absorption. In this embodiment of the invention, first the molten polymer blend is extruded to form the film. After cooling, the polymeric film is stretched to form micropores therein. The resulting microporous film has open pores from top to bottom. When ink is printed onto the surface of the microporous film, it will be imbibed into the ink-receptive micropores in the film. Hence the microporous film provides an excellent infrastructure for ink absorption. Thus this medium can be used for a variety of narrow or wide, indoor or outdoor, personal or commercial ink jet printing applications.

One can achieve different ink absorption capacities by varying the thickness of the microporous film. In accordance with this preferred embodiment, the microporous polymeric film has a thickness in the range of 1 to 3 mils. The microporous film provides a durable print surface.

The hydrophilic polymer melt additive preferably comprises 49-50 wt. % fluorochemical polymer, 49-50 wt. % hydrocarbon surfactant, and 0-1 wt. % residual organic fluorochemicals. Such a hydrophilic polymer melt additive can be purchased from Minnesota Mining and Manufacturing Company, St. Paul, Minn., under the trade name FC-1296. The amount of this hydrophilic polymer melt additive in the total mix is in the range of 1-12 wt. %.

The base polymer for making the film can include, but is not limited to, polyester, cross-linked gelatin, polyethylene, polypropylene, polyurethane, and polyamide. The preferred polymer is polypropylene.

Optionally, UV, thermal or oxygen stabilizers can be incorporated in the polymer blend to provide lightfastness. It is also possible to improve color density of the print image by incorporating one or more dye fixatives.

In accordance with a further preferred embodiment, the hydrophilic microporous polymeric film is laminated to a substrate. Many different substrates can be used, such as paper, cloth, nonwoven fabric, plastic film, metal or ceramic. The preferred substrates are cellulosic paper or synthetic paper. The substrate can be ink (water) absorptive or non-absorptive. Many conventional lamination techniques can be employed to laminate the microporous film onto a substrate. In the case of cellulosic or synthetic paper, the preferred lamination technique is to spray adhesive onto a surface of the substrate or film and then press the substrate and film together with the adhesive therebetween.

The method of manufacture in accordance with the first preferred embodiment comprises the following steps: forming a molten blend of a base polymer and a hydrophilic polymer melt additive; extruding the molten blend to form a polymeric film; and forming micropores in the polymeric film. Preferably the micropores are formed by biaxial stretching of the film in the X and Y directions. The end product can be printed on by applying ink to one side of the microporous polymeric film, e.g., by means of an ink jet printer. In the latter case, the ink was well spread and was instantly absorbed into the film, i.e., the print did not smear when touched after printing.

Another preferred embodiment of the invention comprises a microporous polymeric film having a microparticle coating on at least one surface thereof. If the end product is intended for two-sided printing, then both surfaces of the microporous film should be coated. The microparticle coating comprises colloidal or submicron inorganic pigment particles embedded in an organic polymer binder. For example, the surface coating can be applied in the form of an alumina sol or silica sol. The microporous substrate is preferably made by extruding a polymer to form a film, allowing the film to cool and the and then stretching the film to an extent such that micropores of the desired size are formed in the film. The microparticle coating can be applied to one surface of the microporous film or to the exposed surface of a microporous film which has been laminated to a substrate, e.g., paper. The ink-receptive coating can be applied by dipping, spraying, rod coating, blade coating, flexography, gravure printing or curtain coating. The resulting surface coating is transparent and water-resistant. The surface of the film modified by the coating allows for more efficient absorption of ink.

Special adhesives or hot melts that can facilitate aqueous fluid adsorption and penetration are used in the lamination of the modified or coated microporous film onto paper or other substrates to ensure rapid ink absorption of the laminated media.

In accordance with a preferred embodiment of the invention, a microporous film was made by a hot melt extrusion and biaxial stretching of a polypropylene film in the X and Y directions. Preferably, the thickness of the microporous film is 1 to 3 mils. The micropores in the film were generated by the stretching process. A microparticle coating fluid was then applied to one side of the microporous film. The microparticle coating fluid contained colloidal or submicron inorganic pigment particles and organic polymer(s) as binder(s). Some coating additives, such as surfactant or wetting agent, plasticizer, and defoamer(s), may be added to the coating fluid for coatability and optimization of the coating performance. A preferred coating fluid was made by weighing and mixing the following: 60 to 90 parts (dry, same below) of pigment, e.g., submicron silica sold under the brand name SyloJet 703C and made by W.R. Grace, or alumina sol, sold under the brand name Disperal HP and made by Condea; and 10 to 40 parts of binder(s), e.g., polyurethane aqueous binder sold under the brand name NeoRez R-9320 and made by Zeneca, Inc., or Acrit RKW319SX made by Taisei Chemical Inc., or a combination of these two binders, or polyvinyl alcohol/modified polyvinyl alcohol and a cross-linking agent such as glyoxal. Optionally, the microparticle coating fluid may further comprise 0.5 to 5 parts of surfactant, e.g., octylphenoxypolyethoxyethanol nonionic surfactant (composition: polyethylene glycol octylphenyl ether, >97%; polyethylene glycol, <3%) sold under the brand name Triton X-100 and made by Union Carbide, and 1 to 10 parts of a plasticizer, such as glycerol. After mixing, the coating fluid was applied on one surface of the microporous film using a rod or blade. The coated film was then dried in an oven at 40 to 80 degree Centigrade. The dry coat weight was from 8 to 50 gram per square meter (gsm). A gloss coated film was obtained. The coated film was then printed using ink jet printers. The images dried quickly and the print density was high. In addition, the printed coating had good waterfastness and excellent durability.

In accordance with a further preferred embodiment, the coated microporous polymeric film is laminated to a substrate. The substrates and lamination techniques have been previously described.

While the invention has been described with reference to preferred embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

1. An ink receiving medium comprising a microporous polymeric film, said microporous polymeric film consisting of a polymer and a hydrophilic polymer melt additive.

2. The ink receiving medium as recited in claim 1, wherein said microporous polymeric film has a thickness in the range of 1 to 3 mils.

3. The ink receiving medium as recited in claim 1, wherein said hydrophilic polymer melt additive comprises surfactant.

4. The ink receiving medium as recited in claim 1, wherein the amount of said hydrophilic polymer melt additive is in the range of 1-12 wt. %.

5. The ink receiving medium as recited in claim 1, wherein said polymer is polypropylene.

6. The ink receiving medium as recited in claim 1, further comprising a substrate laminated to said microporous polymeric film.

7. A method for manufacturing an ink receiving medium comprising the steps of:
forming a molten blend of a polymer and a hydrophilic polymer melt additive;
extruding said molten blend to form a polymeric film; and
forming micropores in said polymeric film.

8. The method as recited in claim 7, wherein said forming step comprises stretching said polymeric film.

9. The method as recited in claim 7, wherein said hydrophilic polymer melt additive comprises surfactant.

10. The method as recited in claim 7, further comprising the step of laminating said microporous polymeric film to a substrate.

11. A method of manufacturing a printed product comprising the steps of:
forming a molten blend of a polymer and a hydrophilic polymer melt additive;
extruding said molten blend to form a polymeric film;
forming micropores in said polymeric film; and
applying ink to one side of said microporous polymeric film.

12. The method as recited in claim 11, wherein said forming step comprises stretching said polymeric film.

13. The method as recited in claim 11, further comprising the step of laminating said microporous polymeric film to a substrate prior to said ink applying step.

14. The method as recited in claim 11, wherein said ink applying step comprises ink jet printing.

15. An ink receiving medium comprising:
a microporous polymeric film; and
a microparticle coating applied on one side of said film,
wherein said coating comprises colloidal inorganic particles and a polymeric binder, the weight percent of colloidal inorganic particles being greater than the weight percent of polymeric binder.

16. The ink receiving medium as recited in claim 15, wherein said colloidal inorganic particles are made of silica.

17. The ink receiving medium as recited in claim 15, wherein said colloidal inorganic particles are made of alumina.

18. The ink receiving medium as recited in claim 15, wherein said polymeric binder comprises polyurethane.

19. The ink receiving medium as recited in claim 15, wherein said polymeric binder comprises polyvinyl alcohol.

20. The ink receiving medium as recited in claim 19, wherein said polymeric binder further comprises a cross-linking agent.

21. The ink receiving medium as recited in claim 15, wherein said microporous polymeric film is made of polypropylene.

22. The ink receiving medium as recited in claim 15, wherein said coating further comprises surfactant.

23. The ink receiving medium as recited in claim 15, wherein said coating further comprises plasticizer.

24. The ink receiving medium as recited in claim 15, further comprising a substrate laminated to said microporous polymeric film.

25. A method for manufacturing an ink receiving medium comprising the steps of:
extruding a molten polymer to form a polymeric film;
forming micropores in said polymeric film;
making a microparticle coating fluid comprising colloidal inorganic particles and a polymeric binder, the weight percent of colloidal inorganic particles being greater than the weight percent of polymeric binder;
coating said microporous polymeric film with said microparticle coating fluid; and
drying said coated microporous polymeric film.

26. The method as recited in claim 25, wherein said colloidal inorganic particles are made of silica.

27. The method as recited in claim 25, wherein said colloidal inorganic particles are made of alumina.

28. The method as recited in claim 25, wherein said microporous polymeric film is made of polypropylene.

29. The method as recited in claim 25, wherein said forming step comprises stretching said polymeric film.

30. The method as recited in claim 25, further comprising the step of laminating said microporous polymeric film to a substrate.

31. A method of manufacturing a printed product comprising the steps of:
extruding a molten polymer to form a polymeric film;
forming micropores in said polymeric film;
making a microparticle coating fluid comprising colloidal inorganic particles and a polymeric binder, the weight percent of colloidal inorganic particles being greater than the weight percent of polymeric binder;
coating one side of said microporous polymeric film with said microparticle coating fluid;
drying said coated microporous polymeric film; and
applying ink to said coated side of said microporous polymeric film.

32. The method as recited in claim 31, further comprising the step of laminating said microporous polymeric film to a substrate prior to said ink applying step.

33. The method as recited in claim 31, wherein said ink applying step comprises ink jet printing.

34. An ink receiving medium comprising a microporous stretched polymeric film and a colloidal coating applied on at least one side of said microporous stretched polymeric film, wherein said colloidal coating comprises submicron inorganic pigment particles embedded in a binder.
